(19) United States
(12) Patent Application Publication
(10) Pub. No.: US 2003/0121195 A1
(43) Pub. Date: Jul. 3, 2003

(54) Art display frame

(76) Inventor: Mary Jo Moon, Kensington, MD (US)

Correspondence Address: ZITO TLP, 26005 RIDGE ROAD, SUITE 203, DAMASCUS, MD, 20872, US

(21) Appl. No.: 10/335,639

(22) Filed: Dec. 31, 2002

Related U.S. Application Data
(60) Provisional application No. 60/344,708, filed on Dec. 31, 2001.

(51) Int. Cl. G09F 3/18

(52) U.S. Cl. 40/737; 40/661

(57) ABSTRACT

The present invention provides a holder for the display of art. The holder is mounted to a wall. The art is placed in the holder which des not provide a frame around the art, without attachment to the holder or the wall. The holder does not need to be adjusted to the art nor does the art need to be adjusted to the holder. Art can be readily removed and new art can be placed in the holder without removing the holder from the wall and without resizing of the holder or the art. The art is not damaged by the holder and is protected from damage while exposed to the view of viewers while in the holder. The holder comprises a transparent flat planer face mounted to a wall with an upper and lower support. An opening is formed between the face and the wall by the supports. The art is placed in the opening for display.

### RELATED APPLICATIONS

This application claims the benefit of U.S. Provisional Application No. 60/344,708 filed Dec. 31, 2001.

### FIELD OF THE INVENTION

The present invention relates to display holders for mounting art on a wall in a manner which allows the art to be viewed. More specifically, the disclosed exemplary embodiments are directed to a wall display holder which allows art to be easily inserted into the holder for display and to be quickly and easily removed for replacement with an alternative work without damage to either work. Removal and replacement does not require the use of any tools and does not affect the wall mounting. While mounted on the wall, the art is exposed to the viewer for viewing but protected from direct contact.

### BACKGROUND OF THE INVENTION

It is common to display art, not only in a museum setting but also in galleries and shops. In a museum, each piece of art is individually framed and mounted for display. The display can be permanent, such as the museum's permanent collection, semi-permanent such as a show or traveling collection or art on loan to the museum. In a gallery or shop, the display of art is more temporary and art can be moved several times in a single day for display to a variety of patrons. Because display space is always limited and art must be displayed to be seen and sold, it is important to be able to display a large number of works in a reasonable time with minimal effort and without degradation of the art.

Traditionally art can be framed and hung on a wall by wire hangers. Hanging of individual art requires considerable resources and expense to be invested in each piece of art which is framed and hung for display. This will limit the amount of art which can be properly displayed due to limitations of resources. It is also difficult and time consuming to change the art which is on display, again limiting the quantity and variety of art which can be displayed. Additional art is often stored in racks or bins for browsing by patrons. This is not an optimal setting for viewing and appreciating art and the excessive handling to which art in racks and bins can be subjected can be detrimental to the art.

Art can also be displayed in frames which are self-standing, such as the display taught in U.S. Pat. No. 5,987,794 to Lavi. Traditionally, frame structures mounted on a stand or mounted on a wall are used for the purpose of holding up art, poster boards, signs, and the like during presentations or for presenting an unattended display. Many of these frame structures have the ability to have the display changed by removing old poster board and inserting a replacement poster board in its place through a slot in the frame structure. These frame structures can only accommodate a limited variety of art which is specifically sized for the frame. Also, many steps are required to remove and replace a display, which can be detrimental to the art being displayed.

Patents such as U.S. Pat. No. 5,617,660; U.S. Pat. No. 4,669,209 and U.S. Pat. No. 4,986,013, describe free standing art display frames, which are very inexpensive and easy to assemble and which may be used for the practical framing of a wide variety of pictures, posters, commercial signs and other generally planar display boards or the like, for both residential or commercial use. These frames also accommodate a limited variety of art shapes and sizes and require significant manipulation for the insertion and removal of art.

Pictures, including paintings, posters, photographs and the like, are frequently framed for hanging on a wall or other vertical surface. Conventional systems for hanging pictures include a cable or wire affixed to the rear of a frame, either along the sides or the top of the frame, for suspending the frame on a hook affixed to the wall. Other methods may include clips or brackets affixed to the rear of the frame for suspending the frame on a hook, nail or other fastener affixed to the wall.

In such systems it can be difficult to level the picture when hung. It can also be difficult to re-level the picture, which is required from time to time as the picture shifts due to dusting, knocking or normal settling of the structure in which it is hung. Moreover, it can be difficult to hang the picture because the wire, clip or other hanging means is concealed behind the picture and is thus difficult to align with the hook or fastener when hanging the picture. Providing a visible wire or clip is generally undesirable as it detracts from the aesthetic appeal of the picture. Also, in conventional picture hanging systems each picture must be hung independently, making the alignment of adjacent pictures difficult and generally unchangeable once the pictures are hung.

Patents U.S. Pat. No. 6,119,999 and U.S. Pat. No. 6,272,779 teach apparatus for suspending pictures and display boards. Theses systems also require that each individual work be individually framed and mounted.

It is well known to display information on surfaces, typically boards on which the information is contained. For example, information is displayed on billboards, signs, prints, posters, chalk boards, white boards, these displays are installed by mounting interfaces to mounting structures such as walls, racks, posts or stands. In a general sense, such known applications very ably provide for the display of information. However, such known applications are typically characterized either by their relative permanence or by their relative impermanence because of the surfaces on which the information is contained.

### SUMMARY OF THE INVENTION

It is an object of the present invention to provide a holder for display of art such as paintings, posters, prints, thin sculpture or any form of generally planer shaped art which does not form a frame around the art.

It is an object of the invention to provide a holder for display or art or materials that would normally be displayed on a wall or other vertical surface.

It is an object of the present invention to provide a holder for display of art which can accommodate a large variety of art of varying dimensions without adjustment and which allows for art to be easily changed without damage to the art and without requiring any adjustment to the holder or modification of the art.

It is an object of the present invention to provide a holder for the display of art which is attached to a wall and supports the art without being attached to the art, which allows for the art to be viewed without exposure of the art to the viewer.

The present invention provides a holder for display of art. The holder is mounted to a wall. The art is placed in the holder without attachment to the holder or the wall. The holder does not need to be adjusted to the art nor does the art need to be adjusted to the holder. Art can be readily removed and new art can be placed in the holder without removing the holder from the wall and without resizing of the holder or the art. The art is not damaged by the holder and is protected from direct contact while exposed to be viewed while in the holder.

In a art gallery or art store it is common to display art work, such as posters, prints and paintings, on walls and/or in bins or in racks. Displaying art on a wall is much preferable to bins and racks because the art can be properly viewed which can enhance the likelihood of a sale. In order to display the art on walls, it is necessary to hang the art. Commonly art is framed and then hung. This requires not only choosing an appropriate frame but sizing the frame, mounting the art and hanging the frame on a wall. Once a piece of art is hung on a wall it uses space that cannot be easily allocated to other alternative art.

The present invention allows art to be displayed on a wall without framing the individual work and allows the easy removal of the displayed art and easy substitution of other art. A patron may find a work in a bin or rack. Prior to the present invention the art could only be viewed by removing it from the bin or rack and placing the art on the floor or on a table and leaning the art against a wall. This is an inconvenient and less than optimal method for viewing art which does not let the art be fully appreciated. Art placed on a floor or table is unprotected and can easily be damaged. Also art can not be left in this position for long periods of time because the art will be in the way and subject to potential damage. Prior to the present invention, in order to hang the art in an appropriate location for viewing, it was necessary to frame and mount the art. The present invention allows the patron or the gallery keeper to place the art on a wall for optimal viewing with little effort and without framing. The art can be left there for an extended period of time without damage to allow for extended viewing.

Also, a gallery keeper may desire to change the art on display frequently to present new or varied works to patrons or to maintain a fresh look for the gallery or art shop. The present invention allows for frequent exchange of displayed art thereby providing more effective display space within the limited confines of a gallery or shop without increasing floor space. The present invention also allows for short term display of works on loan, as part of a traveling collection or simply an ad hoc collection to satisfy the tastes of patrons or keepers.

### BRIEF DESCRIPTION OF THE DRAWINGS

Preferred embodiments of the invention are discussed hereinafter in reference to the drawings, wherein like numerals designate corresponding parts in the several figures.

FIG. 1 is a back side perspective view illustrating the set for the art created in the back side of the holder.

FIG. 2 is a front perspective view illustrating the insertion and/or removal of art from the holder.

FIG. 3 is a side view illustrating the art supported within the holder.

### DETAILED DESCRIPTION OF AN EXEMPLARY EMBODIMENT OF THE INVENTION

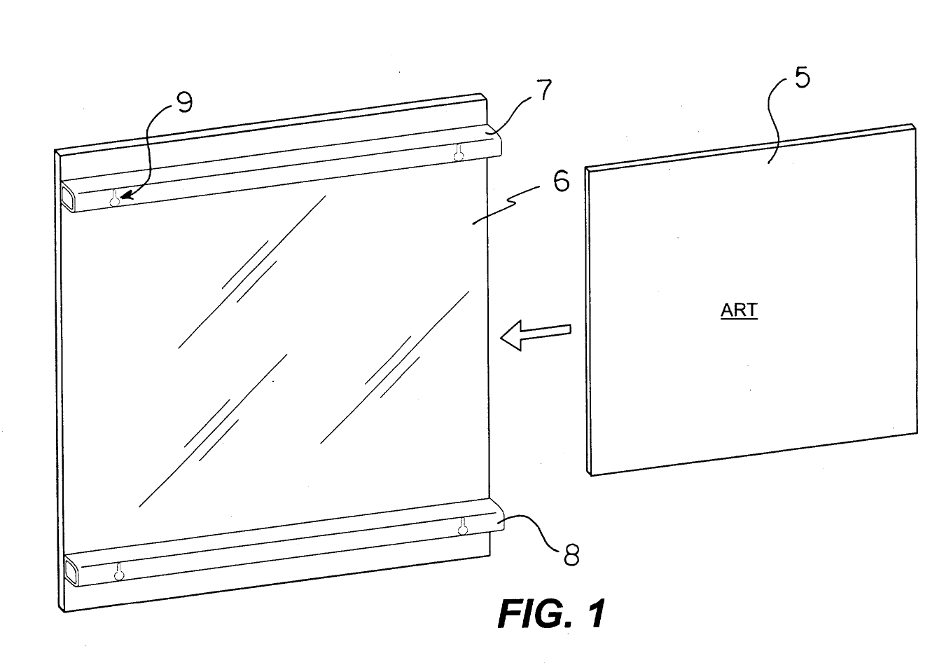

FIG. 1 illustrates the holder of the present invention which is comprised of a flat planer portion which forms the face 6 of the holder and two elongated supports 7 and 8 which are used to secure the face 6 of the holder to a wall and to space the face 6 from a wall. Upper support 7 is also provided with mounting holes 9 for attachment to a wall. Lower support 8 can also be provided with mounting holes for attachment to a wall. It may not be necessary to secure lower support 8 to a wall because the holder can be fully supported by upper support 7 and the weight of the holder will hold lower support 8 in contact with the wall such that lower support 8 acts as a spacer and not a support.

In the exemplary embodiment, face 6 and supports 7 and 8 are illustrated as separate pieces secured together by adhesive means such as glue. However, the face and supports can be formed of a single piece of material by any conventional means. The face must be formed of a transparent material such as glass or plexiglass however, the supports do not need to be transparent.

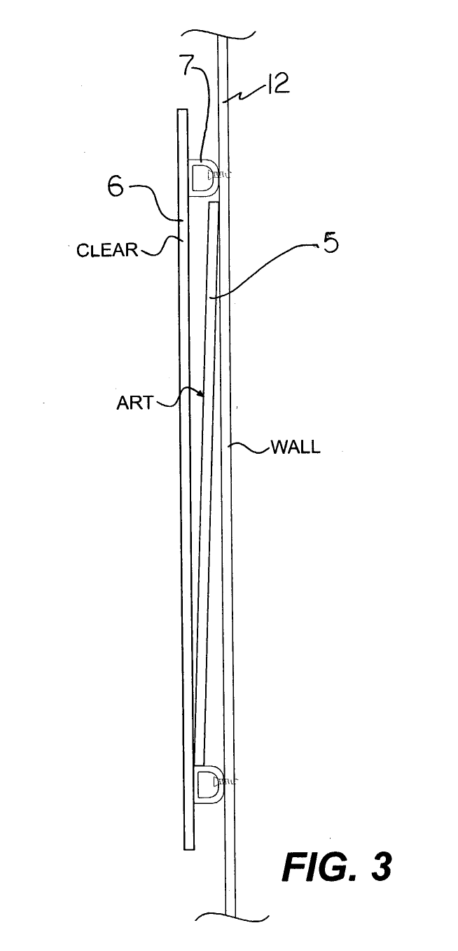

However, when particularly heavy pieces of art are to be displayed in the holder, it may be desirable for the user to also anchor lower support 8 to the wall for added support. Also, because art supported on lower support may have a tendency to tilt back, as illustrated in FIG. 3, the weight of the art may tend to push lower support 8 away from the wall 12. Also a particularly thick piece of art can slip behind the lower support and push the lower support away from the wall.

As illustrated in FIG. 3, the holder forms an opening between the wall 12 and the face 6 of the holder. The supports 7 and 8 are attached to the wall by conventional means such as screws. Art 5 is supported in this opening by lower support 8. The art 5 can lean back against the wall 12 or forward against the face 6 as desired by the user of the present invention.

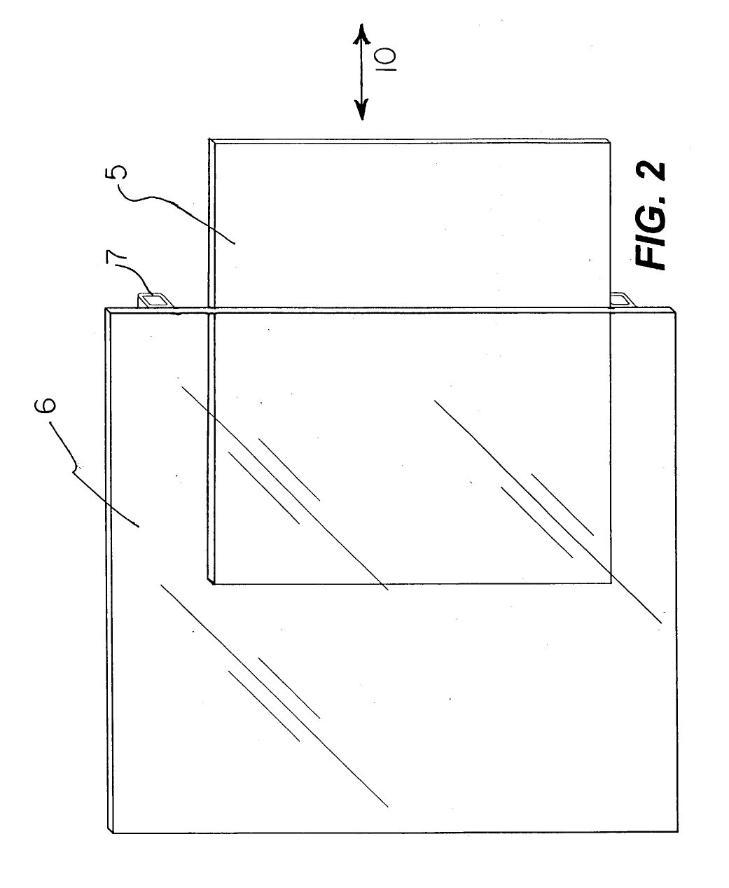

As illustrated by arrow 10 in FIG. 2, art 5 can be easily inserted and removed from the holder by sliding in or out of the slit formed between the holder face 6 and the wall 12.

Because many varying and different embodiments may be made within the scope of the inventive concept herein taught, and because many modifications may be made in the embodiments herein detailed in accordance with the descriptive requirements of the law; it is to be understood that the details herein are to be interpreted as illustrative and not in a limiting sense.

What is claimed is:

1. An art display apparatus for display of art, comprising:
a substantially transparent planer front;
an upper support attached a rear surface of said planer front and having mounting means on a portion of said upper support opposite said attachment to said planer front;
a lower support attached to said rear surface of said planer front of said art display apparatus in an orientation substantially parallel to and at a location and spaced apart from said upper support, for supporting said planer front and said displayed art wherein:
said planer front is secured to a structure and spaced apart from said structure in a substantially parallel orientation.

2. The art display apparatus of claim 1, wherein said mounting means are holes in a surface of said upper support.

3. The art display apparatus of claim 1, further comprising mounting means located on a portion of said lower support opposite said attachment to said planer front.
